(19) United States
(12) Patent Application Publication
(10) Pub. No.: US 2011/0127346 A1
(43) Pub. Date: Jun. 2, 2011

(54) Co-creative Learning and Research Method and Apparatus

(76) Inventor: Ernst von Bezold, Maple Richmond Hill (CA)

(21) Appl. No.: 12/626,690

(22) Filed: Nov. 27, 2009

(51) Int. Cl. A01G 15/00; G09B 19/00

(52) U.S. Cl. 239/2.1; 434/217

(57) ABSTRACT

A method is claimed to provide experiential nonlocal real time interaction between or among a participant or participants, observer or observers, participant-observer or participant-observers, and phenomenon or phenomena by means of presentation of sensory information or semantic mapping, by direct observation or using sensory or semantic representation for example by imaging methods or technology including without limitation, image projection over a distance, e.g., by internet, television or telepathy, so arranged as to permit and facilitate rapid or real time ‘simultaneous’ or prescient attention to the phenomenon and interaction with it, so as to facilitate contemporaneous, or time-delay, or time-advance “feedback” active input to the phenomenon or the phenomenon presentation system, in some sense constituting thereby an entraining and entrained system being modulated by the attention and energetic or related state and interaction or resonance with the phenomenon, of the participant-observer(s), and furthermore their resonance or interaction, whether attentively or consciously intended or consciously or not, with one another and collectively.

A preferable embodiment of this method uses 1) a phenomenon which may vary on account of, without limitation, participant a) attention or b) intention or c) emotion focused by other means or d) thinking or e) a permutation or combination or permutations or combinations of the foregoing;

2) means, as hereinafter illustrated, to present the participant with status data about the phenomenon or phenomena including, as phenomena, status data about observer/participants; said status data being in a preferred embodiment as current as possible (‘real time’) status data, as well as past status data (history) or preview, forecast, projective, or hypothetical data.
3) means to assist the participant in interpreting or understanding a co-relationship between characteristics of the phenomenon and attributes, including the immediate process experience during phenomenon data generation, of the participant, including participant attentional behaviours, attitude mood and emotions, thinking, intention and bodily processes and status, especially the pattern of health.
4) means to provide the participant-observer as user with contextual information and variable, including without limitation user-directed or influenced, information about the state of the system as a whole, both in particular the phenomenon as such as well as user(s) status data, on a data-intensification and withdrawal training basis to develop and optimise the development of user capabilities for remote sensing and for “remote” imaginative perception, inspiration and intuiting, i.e., directly perceived understanding of remote phenomena in part or totality and their course and development without sense-perceptible or imaginatively correlated experience.
4) Means to provide groups of participant with weather and water quality feedback to enable them to change their participation at the time, in the past and moving forward, so as to modify the presented or selected phenomena collectively, for example water quality, especially to improve it, precipitation patterns, ocean current behaviour, and so forth; and to work similarly with other living and inorganic phenomena to improve and stabilise the biosphere, lithosphere, atmosphere, photosphere of interest, that environment of greatest interest being for the time being that of this planet which is our home; especially to enable conscious and intentional ameliorative direct attentive perception and interaction of large numbers of planetary residents in respect of stabilising and otherwise ameliorating climate change by intelligent collective selective conscious interaction with the root or the proximal causes of climate change.

### BACKGROUND

Telepsychokinesis is a scientific fact. This is illustrated by, for example, the work of Marcel Vogel documented in the Proceedings of the Second International Psychotronics conference in Prague, Czechoslovakia, 1973 (a conference also contributed to by Hal Puthoff, William Tiller, and Shafica Karagulla among many others), and the classic early work of J. B. Rhine and others at Duke University and later members of the Parapsychological Association which is a part of the American Association for the Advancement of Science.

Snow crystals forming under locally physically similar conditions are widely held to be highly variable, and this because their formation, and likewise the associative structure of water as a fluid, depends on a weak, and therefore sensitive, bond between hydrogens associated with an oxygen atom, attraxted to nearby oxygens with surplus electric charge to share. This writer asked in a Materials Laboratory poster presentation to material scientists who included visiting researchers and international delegations from the US, Germany, Japan, Soviet Union, etc., at the Fourth International Fracture Conference, Waterloo Ontario Canada, 1977: “Can Loving Attention Affect Snow Crystal Growth?”

The cumulative weight of scientific evidence prior to that has demonstrated, for example with Copper II chloride crystal solutions doped with fluid extracts such as blood or plant juice and grown in for example Petri-dish sized quiet environments, that under controlled conditions, the crystal forms a homeomorphic image of the donor organism which can and has been used for medical diagnosis and in the case of plants, for quality control. See for example Sensitive Crystallization Processes A Demonstration of Formative Forces in the Blood, by Ehrenfried Pfeiffer; second edition, edited by Erica Sabarth and Henry N. Williams, MD. Anthroposophic Press, Spring Valley, N.Y., 1975. The purpose of this technology, as Pfeiffer further elucidated in a memoir, was primarily and strategically to enable the experimenter to develop and apply the perceptive power of thinking to intuit the relationship between the crystal formed and the individual or plant, etc., affecting it through admixture of a fluid sample, thus coming “through creative intuition” to recognise directly (compare dhyana in the yoga supras of Patanjali) the, as it were, ‘noumen behind the phenomenon’; and only secondarily to apply the specific finding to deliver a diagnostic outcome.

A substantial body of work has demonstrated the sensitivity of water to environment, and notably, a human psycho-kinetic influence on water, both through plant growth experiments and through effects on the physical properties of water such as infrared absorption and light scattering. See for example the extracurricular work of Ed Brame, spectroscopist, in Wilmington Del. at E I Dupont de Nemours, highlighted in Krippner, S. and A. Villoldo: The Realms of Healing; Celestial Arts, Millbrae, Calif., 1976.

### PRIOR ART

Besides the foregoing examples, mass experiments have demonstrated dream telepathy (Dream Telepathy. By M. Ullman and S. Krippner of Maimonides Medical Center Dream Laboratory, Brooklyn, N.Y.; 1973) and mass prescient psychokinetic influence at the Princeton University REG remote event detection project (Robert Jahn et. al.), notably prior to the mass trauma attendant on the attacks Sep. 11, 2001 on the World Trade Center, New York, and on the Pentagon, Washington, D.C.

The concept of influencing ice crystal formation by intention, prayer, human energy, has been presented and widely promoted, with copious plausible imaging, though methodologically stringent reproducibility remains a question as of this writing, by the Japanese hado researcher M. Emoto.

More reliably as of this writing, the work of William A. Tiller et al. and their series of substantial monographs on highly reproducible distant psychokinesis replicated using as mediating devices, oscillators previously programmed (‘energised’) by meditators, shows the potential malleability of physical systems in the face of human mental concentration and intent (www.tiller.org).

Recent work has continued to demonstrate results consistent with the foregoing. An intention experiment project was organised by Lynne McTaggart (author of The Intention Experiment; Free Press, New York, 2007) with a team of experimental scientists and hundreds of volunteers distant from the experimental sites. They demonstrated and studied experimentally, changes in properties of systems using water, plants. The experimenters used the internet to recruit and facilitate shared intention, and shared timing—synchrony—of participants seeking to influence the experimental systems at a distance, e.g., for water luminescence, for healing, etc. As of this writing, see http://www.theintentionexperiment.com/the_experiments.

The foregoing findings and reports represent a part of a larger paradigm shift now taking place in world science and culture, prefigured by the uncertainty principle of Heisenberg and the explicitly interactionist epistemologies of nineteenth and twentieth century dialecticians, some of whose revolutionary political application of such a powerful principle as interactivity significantly polarised and probably delayed its more widely spreading, deeper scientifically comprehensive application, e.g., to spiritual research and application in, e.g., human healing and environmental renewal, into the post-Communist period at the end of the twentieth century. In effect, the recent developments and inventions develop and address a previously undervalued potential which has been overhanging the market.

### DESCRIPTION OF THE INVENTION

A simple preferable embodiment of the invention starts out by making use of a reagent system, for example, similar to the many described above, initially to provide real-time feedback to the participant. In this example an automatic (therefore requiring no attention to operate the physical environment) self-cleaning snow crystal growing system is used to present a snow crystal growing site, or a sense-perceptible representation such as a visual, auditory, tactile, thermal, etc., image or images of a site, to a participant, by means such as a video display or television, amplified filtered sound, etc., for example by projection (e.g., onto a surface, such as a screen or the moon), on the internet, etc.

The participant is able to observe the particular phenomenon, i.e., here, the snow crystal as it develops. In a preferred embodiment the participant is asked to bring impartial appreciation to the process of observing, rather than unaffective neutrality or any further specific intention.

As a nonessential clarifying feedback facilitation method using a multiple control design adapted from Ullman and Krippner (1973, op. cit.), the participant may be presented for comparison, control crystals grown under comparable conditions, i.e., at the same time in more or less the same place, with or without a set-theoretically or other analytically based highlight of unique net difference, if any, between the crystal grown under an attentionally or intentionally highlighting condition and the controls.

As the participant's ability to provide formative facilitation to the crystal becomes more evident, the presentation may optionally be attenuated or intensified, preferably by user-directed modulation, to encourage imaginative perception of the growing crystal leading to clairvoyant perception of the forming crystal independent of the presentation. Without limitation, a coordinate remote viewing application is another potential interactive resonant or ‘feedback’ path. It will be evident from remote viewing literature of the twentieth century (e.g., Rudolf Steiner; Robert A. Monroe, David Moorehouse, Courtney Brown) that selecting the ‘time’ of viewing extends the potential of croos-time interaction or resonance research from an instrumental quantum level to the small-scale macroscopic system of the growing snow crystal.

The therapeutic feedback for patients and therapist and the artistic potential of snow crystal growing are among the motivating factors which in this example increase the participant's energetic concentration and compliance with plausible and reasonable protocol.

At this point, in respect of the participant's continued participation, large numbers of participants who may or may not have worked ‘together’, whether at the ‘same’ time or not, with snow crystals or some similarly sensitive system, may work together to love snow crystals as they fall onto land, lakes, rivers, etc. The literature on love and the healing response of plants to loved water, would motivate such work, and participant's direct perception would provide feedback, along with local snow and water sampling trials, to contribute to a basis for judgement of effectiveness.

Similarly, sufficiently skilled participants, having developed love-based intuition and exact clairvoyance using this system, would be in a developing position en masse to guide local and planetary weather to greater harmony and stability.

1. A method is claimed to make accessible to many people, especially children and the elderly, sick and poor, and to facilitate, learning to love snow crystals, snow crystals' growing, weather, water, nature, and others.

2. A method is claimed to make accessible to many people, and to facilitate, development of further insightful, empathic and creative capacities including without limitation as precise, clear and steady capacities for contemplative imaginative, inspired and intuitive knowledge, for compassion, for artistic, peaceful co-creation of life, with others and with nature.

3. Dependent on the foregoing a method is claimed to make accessible to many people, and facilitate, in particular, learning to help and heal oneself, others, the life of nature, the world

4. Dependent on the foregoing method is claimed, from the foregoing, to make accessible to many people, and to facilitate, learning to make more beautiful snow crystals as works of art and in nature and, having particular regard for the work of Viktor Schauberger (Austria, 20th c.), learning to produce and protect healthier water and environment, notwithstanding contrary polluting chemical, electromagnetic and human psychoenergetic influences.

5. Dependent on the foregoing a method is claimed dependent on the foregoing of modifying weather telekinetically with a precise knowledge of causes and effects.

6. A method is claimed to measure spacial-energetic-experiential-temporal-informational apparent propagation characteristics of participant input and participant-phenomenon resonance, e.g., without limitation, attentional-sensory somatic-affective-cognitive-intentional state in respect of correlated covariance of internet-presented sensing indicator phenomena, e.g., snow crystals; for example, to collect statistically validated data on variations in quality, magnitude, timing, of changes in the presented and correlated indicators (snow crystal activity and form, participant activity and status) to, for example, measure effective propagation speeds and their constancy or variation, e.g, to test for a Michelson-Morley-like spacial drag effect in respect of ‘propagation’ of psychoenergetic-state-associated participant-indicator correlations.
